(19) United States
(12) Patent Application Publication
(10) Pub. No.: US 2024/0092612 A1
(43) Pub. Date: Mar. 21, 2024

(54) DEVICE FOR HELPING A VEHICLE TO NEGOTIATE AN OBSTACLE

(71) Applicant: MYD'L, Saint-Denis (FR)

(72) Inventors: Pierre BELMAN, SAINT DENIS (FR); Frédéric ENGLER, SAINT DENIS (FR)

(73) Assignee: MYD'L, Saint-Denis (FR)

(21) Appl. No.: 18/038,533

(22) PCT Filed: Nov. 24, 2021
(86) PCT No.: PCT/FR2021/052086

§ 371 Date: May 24, 2023

(30) Foreign Application Priority Data
Nov. 26, 2020 (FR) 2012173

(51) Int. Cl. B66B 9/08

(52) U.S. Cl. CPC B66B 9/0853

(57) ABSTRACT

A device, for helping a wheeled vehicle to negotiate an obstacle, includes a stationary framework, a substantially horizontal frame movable between a high position and a low position in which the frame rests on the framework, and an assembly for vertically translating the frame, the assembly is supported by the framework and supports the frame, the drive assembly includes a pair of shears with X-shaped articulated arms, each arm having an end hinged to the frame and an end hinged to the framework, by translation at one end, a drive actuator for driving the frame between the low and high positions. A plate is supported by the frame and, when the frame is in the high position, translatably movable horizontally relative to the frame, so as to come into contact with a vertex of the obstacle, the plate being flush with the neighboring ground when in the low position.

### FIELD OF THE INVENTION

The present invention relates to the field of obstacle negotiation helping.

The present invention is directed to a device for helping a vehicle to pass over one or more steps or a threshold, especially for persons with reduced mobility using a wheelchair or for persons moving a wheeled trolley intended for transporting objects.

### BACKGROUND

It is common for a shop or business, or even the entrance to a residential building, to have one or more internal or external steps which constitute an obstacle. Steps can also be found for access to terraces.

Such an obstacle is generally a few tens of centimeters high and is often impassable for a person with reduced mobility or delivery trolleys.

Deployable ramps are adapted to heights up to about 20 cm. Beyond this, the ramps become very long to maintain a low slope. It is then preferable to provide a lifting device.

However, known lifting devices occupy a large space, at least 1 m2, thus reducing the remaining surface area for a staircase, while at the same time having a fairly low rate of use and requiring time-consuming structural work which has a visual impact on the premises.

The applicant has sought to make better use of the available surface area and volume.

### SUMMARY

The invention provides a device for helping a wheeled vehicle to pass over an obstacle, especially for persons with reduced mobility. The device comprises a stationary framework 11, a substantially horizontal frame, movable between a high position and a low position in which said frame rests on the framework, a drive assembly for vertically translationally driving the frame, supported by the framework and supporting the frame, and a plate supported by the frame. The plate is horizontally translationally movable relative to the frame, in the high position, to contact a vertex of the obstacle. The plate is designed to be flush with the surrounding ground in the low position. Said drive assembly comprises a pair of X-shaped hinged shear arms, a drive actuator between the high and low positions of the frame, and a shear disengaging mechanism active from and in proximity to the low position and offering less leverage than the leverage of the scissors in proximity to the low position. Each shear arm has an end hinged to the frame and an end hinged to the framework, with translation at one of said ends. This reduces the force exerted on the scissors at start-up, hence the implementation of a more compact actuator.

In the low position, the device can be flush with the ground surface of the existing premises. In other words, an excavation is provided in the ground of the premises with a surface adapted to the surface of the device and with a depth corresponding to the height of the device in the low position. The height of the device in the low position can be between 8 and 15 cm. Generally, the depth of the excavation is less than the thickness of the ground slab in the case of a concrete slab. The power source of the actuator may be distant from the excavation. The obstacle itself, generally steps, remains intact. In particular, the original width is preserved.

In one embodiment, said translation is guided by an oblong port. The translation is a sliding motion. The mechanism is robust and compact.

In one embodiment, said translation is guided by at least one connecting rod.

In one alternative embodiment, a first arm comprises an end hinged to the frame and an end hinged to the framework, without translation, and a second arm comprises an end hinged to the frame and an end hinged to the framework, with translation at said ends. An advancement movement of the frame towards the obstacle is achieved, the movement being oblique.

In one embodiment, said disengaging mechanism comprises a carriage driven by said actuator, the actuator having a stroke with a first end corresponding to the low position and a second end corresponding to the high position, with a first stroke part inactive on the scissors and a second stroke part active on the scissors, the first stroke part extending from the first stroke end to the second stroke part and the second stroke part extending to the second stroke end, the actuator comprising an end hinged to the framework and an end hinged to the carriage. The actuator by retracting raises the frame and by extending lowers the frame. The maximum force of the actuator can be shifted from the beginning of the stroke to the beginning of the second stroke part and thus be applied at a time when the shear lift ratio is more favorable. This is because a shear lift mechanism with a constant load has a movement multiplier and force divider effect at the beginning of the stroke and a movement divider and force multiplier effect at the beginning of the stroke. At constant load, the maximum force required from the actuator is at the beginning of the stroke and the minimum force at the end of the stroke, while at constant actuator speed, the maximum vertical speed of the frame occurs at the beginning of the stroke and the minimum speed at the end of the stroke.

In one embodiment, said disengaging mechanism comprises a tie rod comprising an end hinged to the actuator and an end supporting a spacer, the carriage connecting several tie rods. The spacer is configured to lift the frame in the first stroke part before the scissors take over in the second stroke part.

In one embodiment, two tie rods are provided at each movable end of an actuator. An axis passes through the movable end of the actuator, the oblong port in the arms and a drilled hole provided in the tie rods.

In one embodiment, said disengaging mechanism comprises at least one of a ramp integral with the framework, projecting towards the frame and a ramp integral with the framework, projecting towards the framework, the spacer being disposed in contact with said ramp and transmitting the lifting force from the framework to the frame during the first stroke part. The at least one ramp may be triangular in shape. Over the second stroke part, the spacer descends back towards the framework and then rests on the framework.

In one embodiment, the spacer comprises a rolling bearing rolling on the ramp integral with the framework and a rolling bearing rolling on the ramp integral with the frame, the bearings having external surfaces of revolution, the spacer being disposed between said ramps and transmitting the lifting force from the ramp integral with the framework to the ramp integral with the frame during the first stroke part. Friction is reduced.

In one embodiment, the bearings are mounted between two arms of the scissors.

In one embodiment, the ramp integral with the framework and the ramp integral with the frame are longitudinally along the axis of the carriage in the same region and arranged in planes parallel to the axis of the carriage.

In one embodiment, the ramps have a constant slope. The force is constant over the first stroke part.

In one embodiment, the shear arms are rectangular cross-section bars.

In one embodiment, each arm is hinged to another of said arms through a central hinge axis.

In one embodiment, at least one crossbar connects two parallel arms.

In one embodiment, the stationary framework is provided with height adjustable feet, especially relative to a pit ground on which the framework rests.

In one embodiment, the frame comprises studs supporting the frame in the low position, the drive assembly being disengaged from the weight of the frame in the low position. The load on the drive assembly is reduced.

In one embodiment, at least one shear arm comprises an oblong port sliding with the actuator, said oblong port being traversed in the first stroke part, the actuator abutting against one end of said oblong port in the second stroke part. The actuator may have a finger mounted in said oblong port. Thus, in the low position, the actuator finger is located at the end of the oblong port adjacent to the corresponding end of the arm. During the first stroke part, the actuator finger travels along the oblong port until it abuts against the end of the oblong port adjacent to the end of the arm. In the second stroke part, the actuator finger abuts against the end of the oblong port adjacent to the end of the arm. In the high position, the actuator finger remains abutting against the upper end of the oblong port. The scissors have the maximum amplification and thus the minimum transfer of forces to the actuator in the high position.

In one embodiment, the device is symmetrical with respect to a vertical plane. Torsional forces are reduced.

In one embodiment, said actuator is disposed between the scissors in the low position. The overall size is reduced.

In one embodiment, said carriage has a substantially horizontal displacement over the second stroke part. The construction is robust.

In one embodiment, the elevation of the frame as a function of the actuator is independent of the scissors over the first stroke part and dependent on the scissors over the second stroke part.

In one embodiment, the device comprises a guard post integral with the movable plate and provided with flaps, disposed on three sides of the movable plate, the flaps being retracted in the low position and raised in the high position and at least during the second stroke part. A wheeled vehicle, for example a wheelchair, a goods trolley, is stable on the plate.

In one embodiment, the actuator has a constant speed from the first to the second stroke part. The actuator may comprise one or two double-acting hydraulic jacks. The hydraulic power source may comprise a hydraulic unit located a few meters from the device at an adapted location.

### BRIEF DESCRIPTION OF THE DRAWINGS

Further characteristics and advantages of the invention will become apparent upon examining the following detailed description, and the appended drawings, in which:

FIG. 1 is a schematic perspective view of a negotiation help device in a circulation space, in the low position according to one aspect of the invention.

FIG. 2 is a schematic cross-sectional view of the negotiation help device in the low position according to one aspect of the invention.

FIG. 3 is a schematic perspective view of the negotiation help device, in a circulation space, in a safe position according to one aspect of the invention.

FIG. 4 is a schematic cross-sectional view of the negotiation help device in the first stroke part according to one aspect of the invention.

FIG. 5 is a schematic perspective view of a negotiation help device, in the high position, the frame being in transparent grey, according to one aspect of the invention.

FIG. 6 is a schematic perspective view of a negotiation help device, in a circulation space, in the high position, according to one aspect of the invention.

FIG. 7 is a schematic cross-sectional view of a negotiation help device, in the high position, according to one aspect of the invention.

FIG. 8 is a schematic perspective view of a negotiation help device, in a circulation space, in the negotiation position, according to one aspect of the invention.

FIG. 9 is a schematic cross-sectional view of a negotiation help device very close to the negotiation position, according to one aspect of the invention.

### DETAILED DESCRIPTION OF THE PREFERRED EMBODIMENTS

The appended drawings may serve not only to complete the invention, but also to contribute to its definition, if necessary.

In an attempt to provide helping in negotiating an obstacle in a circulation place, the applicant realized that known lifting systems require partial destruction and reconstruction of the structure. These operations are expensive and time-consuming. The consultation of an architect and an engineering office is in general necessary. The ground below is also affected. Networks are moved. A large number of trades are related to the project, which means that rigorous coordination is required and there is a high risk of delays in the work. In addition, the reconstruction generally uses concrete, which means that it has to be dried before the rest of the work is carried out. The decoration then has to be reworked or repaired.

Once the lift system has been installed, the user of the structure will realize that more than 99% of the circulation flow is directed towards the remaining narrow staircase steps by more than 99%.

The invention improves this situation.

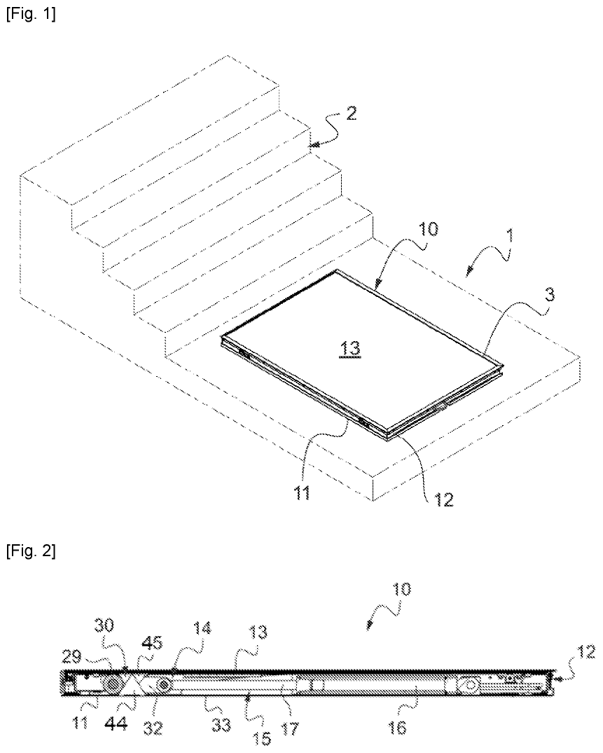

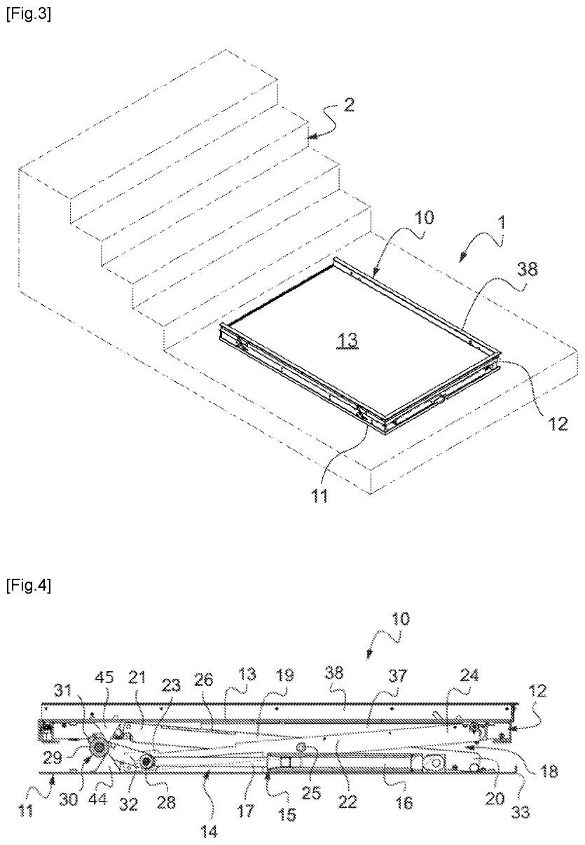

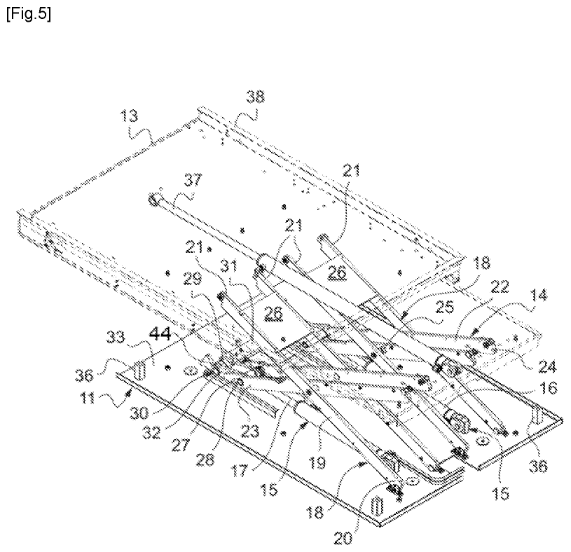

As illustrated in FIGS. 1, 3, 6 and 8, a circulation space comprises a low ground 1 and an obstacle formed by staircase steps 2, here four in number. The obstacle height is in the range of 50 to 85 cm. A rectangular reserve 3 is provided in the low ground, in proximity to the first staircase step from the low ground. The reserve 3 is located a few centimeters from the first staircase step. Reserve 3 is a parallelepiped excavation. The depth of the reserve 3 is between 8 and 15 cm.

The negotiation help device 10 is illustrated in the figures. The negotiation help device 10 is provided for lifting a person or an object, especially a person standing, a person sitting on a wheelchair or a goods trolley, for example a pallet truck carrying a pallet of goods.

The negotiation help device 10 comprises a stationary framework 11. The stationary framework 11 is rectangular in shape. The stationary framework 11 may be made of stainless steel or protected against corrosion. The framework 11 is attached to the ground when installed.

The negotiation help device 10 comprises a frame 12. The frame 12 is rectangular in shape. The frame 12 has substantially the same length and width dimensions as the framework 11. The frame 12 is mechanically welded. The frame 12 is substantially horizontal. A plate 13 rests on the frame 12. The plate 13 has an upper working surface on which a user can walk or drive a vehicle.

In a low position, the frame 12 rests on the framework 11. The frame 12 is movable between a high position and a low position. In the high position, the height of the plate 13 corresponds to the height of the obstacle to pass over so that circulation from the upper working surface to the obstacle is possible in an easy manner. In the low position, the upper working surface is flush with the surrounding ground. Optionally, the upper working surface may be made of the same material as the surrounding ground.

The negotiation help device 10 comprises a drive assembly 14 for driving the frame 12 relative to the framework 11. The drive assembly 14 is vertically translationally active. The drive assembly 14 is supported by the framework 11. The drive assembly 14 supports the frame 12. In the low position, the drive assembly 14 is housed in the space left free between the framework 11 and the frame 12. The drive assembly 14 comprises at least one actuator 15 for driving between the low position and the high position of the frame 12. In the embodiment represented, the drive assembly 14 comprises two linear hydraulic jacks. The jacks have parallel axes. The jacks are powered by a remote hydraulic unit. The hydraulic unit is arranged outside the help device 10.

Said at least one actuator 15 comprises a fixed part 16 hinged to the framework 11 and a movable part 17. The fixed part 16 may have a very slight rotational movement with respect to the hinge to the framework 11. In the low position, the actuator 15 is parallel to the framework 11, that is in practice substantially horizontal. The actuator 15 may have a constant speed.

The drive assembly 14 comprises a pair of scissors 18 with X-shaped hinged arms. In the embodiment represented, four pairs of scissors 18 are provided. The pairs of scissors 18 are parallel.

Each pair of scissors 18 comprises two X-shaped arms. The arms are hinged to each other substantially in the middle thereof. Each arm comprises a lower end supported by the framework 11 and an upper end supported by the frame 12, it being understood that in the low position the ends of the arms are substantially at the same level vertically.

In the embodiment represented, a first arm 19 comprises a lower end 20 hinged to the framework 11 in the vicinity of the fixed part 16 of the actuator 15 and an upper end 21 connected to the frame 12 through a slide or finger moving in an oblong port provided in the frame 12. A second arm 22 comprises an upper end 24 hinged to the frame 12 and a lower end 23 in contact with the framework 11. Said lower end 23 of the second arm 22 may roll or slide on an upper surface of the framework 11. To ensure substantially vertical movement of the frame 12, the hinge at the lower end 20 of the first arm 19 and the hinge at the upper end 24 of the second arm 22 are disposed on the side of the fixed part 16 of the actuator 15 while the upper end 21 of the first arm 19 and the lower end 23 of the second arm 22 are disposed on the side of the movable part 17 of said actuator 15.

Each arm 19, 22 comprises a rectangular cross-section bar. Cut-outs may be provided in the bar to promote compactness of the device in the low position. In a transverse cross-section view, each arm 19, 22 has a height greater than the width. The first arm 19 and the second arm 22 are hinged together through a central hinge axis 25. The axis 25 may be screwed or held in place by circlips.

Further, the first arms 19 of two adjacent pairs of scissors 18 are connected to each other by a gap 26. The gap 26 is disposed between the central axis 25 and the upper end 21 of the first arms. The gap 26 is mounted flush with an upper surface of the arms. The gap 26 may have the shape of a rectangular plate. The gap 26 may have four end lugs received in notches provided in the arms 19. The gap 26 may be welded to the arms. The rigidity is high.

In the second arm 22, in proximity to the lower end 23, an oblong port 27 is provided. The oblong port 27 has a main axis aligned with the main axis of said second arm 22. Each pair of scissors 18 is arranged to move in a vertical plane parallel to the axis of the actuator 15. The movable part 17 of the actuator 15 comprises a shaft 28 forming a Tee with a body of the movable part 17. The shaft 28 is disposed at the end of the movable part 17 opposite to the fixed part 16. Each actuator 15 is mounted between two pairs of scissors 18. In the embodiment represented, two actuators 15 are provided, each mounted between two pairs of scissors 18. Said actuator 15 is disposed between the pairs of scissors 18 in the low position.

Said shaft 28 passes through the oblong port 27 of each second arm 22 of each pair of scissors 18, on either side of the body of the movable part 17. The sub-assembly formed by an actuator 15 and both pairs of scissors 18 cooperating with said actuator 15 is symmetrical with respect to a vertical plane. The help device 10 is symmetrical with respect to a vertical plane.

In a first stroke part of the actuator 15, said shaft 28 moves from the end of the oblong port 27 distant to the fixed part 16 of the actuator 15 to the end of the oblong port 27 close to the fixed part 16 of the actuator 15. In the first stroke part, the actuator 15 is inactive on the shear pairs 18. The actuator 15 has a second stroke part active on the scissors 18. In the second stroke part of the actuator 15, said shaft 28 abuts against the end of the oblong port 27 close to the fixed part 16. The actuator 15 is then active on the shear pairs 18. The lifting stroke corresponds to a retraction stroke of the actuator 15 while the lowering stroke corresponds to an extension stroke of the actuator 15. The retraction of the actuator 15 causes the lower end 23 of the second arm 22 to move towards the lower end 20 of the first arm 19 and the frame 12 to move translationally vertically. Thus the sliding oblong port 27 is traversed in the first stroke part, the actuator 15 abutting against the end of said oblong port 27 in the second stroke part.

The help device 10 further comprises a disengaging mechanism 30 for disengaging the scissors 18. The shear disengaging mechanism 30 is active from and in proximity to the low position. This is because, by design, scissors 18 require a high force at the beginning of the stroke. In order to relieve the force required from the actuator 15 at the beginning of the lifting stroke, the disengaging mechanism 30 of the scissors 18 performs the beginning of the lifting stroke. During the first stroke part of the actuator 15 corresponding to the first part of the lifting stroke, the disengaging mechanism 30 offers a lower leverage than the leverage of the scissors 18.

The disengaging mechanism 30 comprises a carriage 31 driven by said actuator 15. The carriage 31 is movable over a stroke having a first end corresponding to the low position and a second end corresponding to the high position. The carriage 31 is common to the actuators 15. The carriage 31 is connected to the actuator 15 by tie rods 32. The carriage 31 is attached to each tie rod. Each tie rod 32 comprises an end hinged to the moving part 17 of the actuator 15, especially to said shaft 28. Each tie rod 32 has the form of a rectangular plate with two through holes. Each tie rod 32 comprises another end supporting a spacer 29. The spacer 29, in the embodiment represented, comprises a pair of bearings mounted in tandem. Both bearings of a spacer 29 are mounted to a common shaft. Said common shaft is also mounted in the through hole of a tie rod 32 on either side of the bearings. In other words, two tie rods 32 frame a pair of bearings. On the shaft 28 of the movable part 17 of the actuator 15, the arms can be mounted outside the tie rods 32. The tie rods 32 extend beyond the shaft 28 of the movable part 17 of the actuator 15 on the side opposite to the fixed part 16 of the actuator 15. Said carriage 31 has a substantially horizontal movement over the second stroke part.

The framework 11 comprises a body 33, for example formed of sheet metal, offering an upper surface carrying the drive assembly 14, and at least one lower ramp 44. In the embodiment represented, two lower ramps 44 are provided. Each lower ramp 44 is attached to the upper surface of the body 33. Each lower ramp 44 is in the form of a triangle with a base resting on the body 33 and attached to said body 33. The thickness of the lower ramp 44 is directed along the transverse axis of the help device 10. The triangle may be isosceles with a slightly rounded vertex. One of both bearings of the spacer 29 is arranged to roll on the lower ramp 44 over the first stroke part. Over the second stroke part, the bearings of the spacer 29 roll on said upper surface of the body 33. The lower ramp 44 forms part of the disengaging mechanism 30. The lower ramp 44 projects towards the frame 12.

The disengaging mechanism 30 also includes an upper ramp 45 attached to the frame 12. The upper ramp 45 projects towards the framework 11. The upper ramp 45 is laterally offset from the lower ramp 44. In the low position, the upper ramp 45 and the lower ramp 44 are in the vicinity of each other. The upper ramp 45 and the lower ramp 44 are disposed in parallel planes. The lateral spacing between the upper ramp 45 and the lower ramp 44 is equal to the lateral spacing between both bearings of a spacer 29. The other of both bearings of the spacer 29 is disposed to roll on the lower ramp 44 over the first stroke part.

In the low position, both bearings of the spacer 29 are arranged in front of the ramps 44, 45. Over the first stroke part, both bearings of the spacer 29 pulled by the tie rods 32, which are in turn pulled by the actuator 15, each roll on a front slope of the lower ramp 44 and of the upper ramp 45. The spacer 29 is thus raised by the lower ramp 44 to a first height and simultaneously raises the upper ramp 45 and thus the frame 12 by a second height equal to the first height relative to the spacer 29 and the sum of both heights relative to the framework 11. The projection of the length of the front slope in a horizontal plane is substantially equal into the projection of the length of the oblong port 27. Thus, the spacer 29 reaches the vertex of the ramp simultaneously with the shaft 28 of the movable part 17 of the actuator 15 abutting against the arm at the end of the oblong port 27. This is defined as the end of the first stroke part.

Over the second stroke part, the bearings follow the rearward slope of the lower ramp 44 and descend towards the body 33 of the framework 11. The upper ramp 45, being integral with the frame 12, follows the rise of the frame 12 caused by the shear pairs 18. The spacer 29 is inactive over the second stroke part. Over the first stroke part, the spacer 29 ensures elevation of the frame 12 by transmitting the force from the actuator 15 and transforming the horizontal force into the vertical force.

The bearings may be rolling bearings having external surfaces of revolution. The ramps 44, 45 may have a constant slope.

The framework 11 may be provided with height adjustable feet, especially in relation to a pit ground on which the framework 11 rests. Alternatively, the body 33 of the framework 11 rests on a pit ground.

The framework 11 comprises studs 36 supporting the frame 12 in the low position. Here, the studs 36 are four in number, each disposed near a corner of the body 33 of the framework 11. The studs 36 can be attached to the body 33 of the framework 11, especially by welding. The studs 36 project from the upper surface of the body 33 of the framework 11. In this way, the drive assembly 14 is disengaged from the weight of the frame 12 in the low position.

The help device 10 also comprises the movable plate 13. The plate 13 is supported by the frame 12. The plate 13 is horizontally translationally mounted relative to the frame 12 in the high position. The plate 13 is intended to contact a vertex of the obstacle. The plate 13 is designed to be flush with the surrounding ground in the low position. The plate 13 forms an upper surface of the help device 10. Between the frame 12 and the plate 13, slides may be provided. The movement of the plate 13 relative to the frame 12 may be ensured by an actuator 37, for example a hydraulic jack.

The plate 13 comprises a guard post 38. The guard post 38 is provided with flaps. The flaps are arranged on three sides of the movable plate 13. The flaps are retracted in the low position. The flaps are raised in the high position and at least during the second stroke part. The risk of falling is limited. The flaps are moved by at least one actuator housed in the frame 12. Two actuators may be provided symmetrically each driving one side of the guard post 38. The actuators are electrically operated, for example screw jacks. The actuators may be connected to the guard post 38 by connecting rods or an X-scissors. The actuators may be elongated along the length of the frame 12. Electrical safeguards may be provided, especially protection against excessive current, limitation of the operating time of the actuators and/or protection against excessive delay between the early abutment of the first actuator and the early abutment of the last actuator. Current protection prevents the actuators from heating up in the event of a foreign body causing a blockage. Operating time limitation prevents excessive operation in the event of worm gear breakage. Protection against excessive delay between the early abutment of the first actuator and the early abutment of the last actuator is a mechanical differential protection. Provision may be made for a return to the retracted position of the guard post 38 followed by an attempt to move to the active position and if this fails, stopping the actuator.

In a degraded mode, provision is made to deactivate the guard post 38. This avoids a complete shutdown of the help device. The help device can continue to provide an essential service, for example, while waiting for the delivery of a spare part.

Advantageously, the actuator 15 has constant speed from the first to the second stroke part.

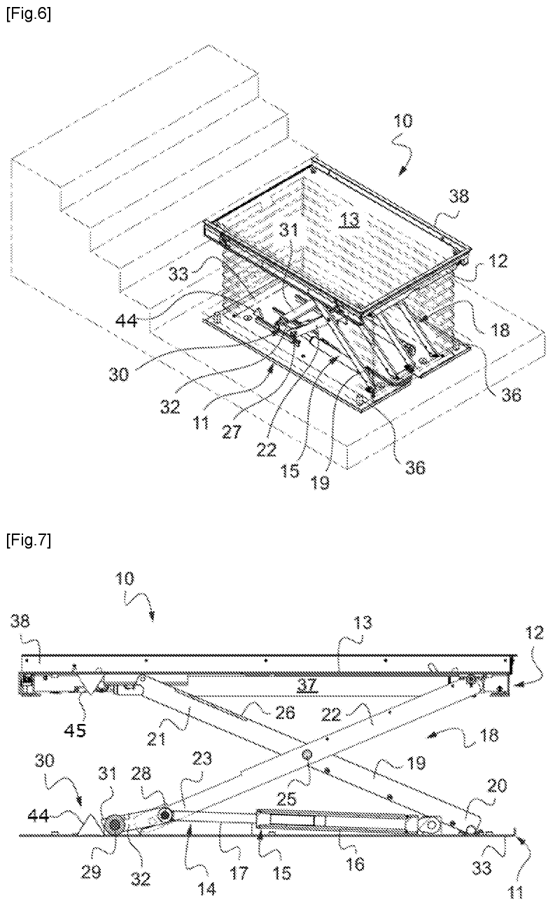

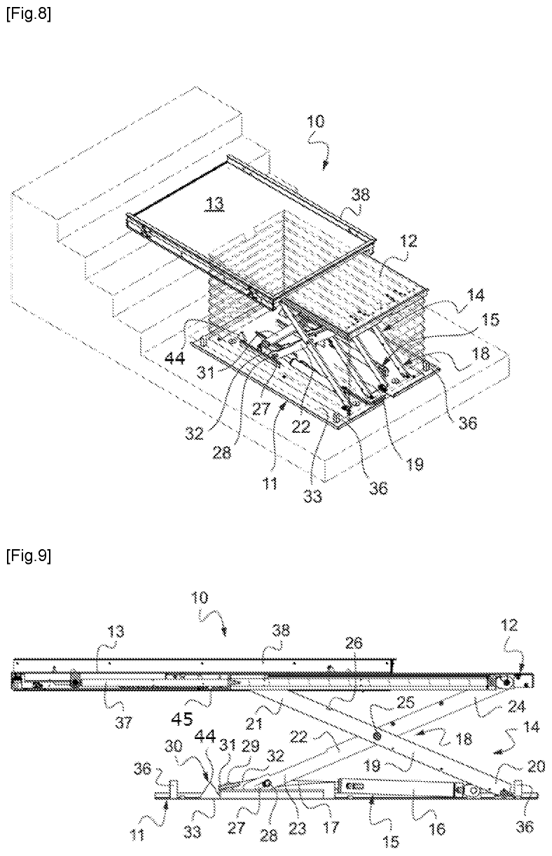

In FIGS. 6 and 8, a bellows surrounding the drive assembly 14 is shown. The bellows comprises a lower edge connected to the framework 11 and an upper edge connected to the frame 12. The lower edge is sealed to the periphery of the framework 11 and the upper edge is sealed to the periphery of the frame 12. The bellows are vertically expandable. The bellows reduce intrusion of dust, water and foreign matter. The bellows reduce the risk of accidents.

By virtue of the invention, the elevation of the frame 12 as a function of the actuator 15 is independent of the scissors 18 over the first stroke part and dependent on the scissors 18 over the second stroke part. In this way, the mechanical characteristics of the scissors 18 are taken advantage of in the operating zone where said characteristics are most interesting, while at the same time the main drawback of the scissors 18, namely the force at start-up, is remedied. Furthermore, the stability of the scissors 18 in the high position and the low forces transmitted to the actuator 15 in the high position are also taken advantage of. The help device 10 is particularly robust.

1. A device (10) for helping a wheeled vehicle, especially for a person with reduced mobility, to pass over an obstacle, the device comprising:
a stationary framework (11),
a substantially horizontal frame (12), the frame (12) being movable between a high position and a low position in which said frame (12) rests on the framework (11), and
a drive assembly (14) for vertically translationally driving the frame (12), supported by the framework (11) and supporting the frame (12), said drive assembly (14) comprising:
a pair of scissors (18) with X-shaped hinged arms, each shear arm comprising an end hinged to the frame (12) and an end hinged to the framework (11), with translation at one of said ends,
an actuator (15) for driving the frame (12) between the low and high positions, and
a mechanism (30) for disengaging the scissors (18), active from and in proximity to the low position and offering a leverage lower than the leverage of the scissors (18) in proximity to the low position,
a plate (13) supported by the frame (12) and horizontally translationally movable relative to the frame (12), in the high position, to come into contact with a vertex of the obstacle, the plate (13) being designed to be flush with the surrounding ground, in the low position.

2. The device according to claim 1, wherein said disengaging mechanism (30) comprises:
a carriage (31) driven by said actuator (15), having a stroke with a first end corresponding to the low position and a second end corresponding to the high position, the actuator (15) having a first stroke part inactive on the scissors (18) and a second stroke part active on the scissors (18), the first stroke part extending from the first stroke end to the second stroke part, and the second stroke part extending to the second stroke end, the actuator (15) comprising an end hinged to the framework (11) and an end hinged to the carriage (31),
a tie rod (32) comprising an end hinged to the actuator (15) and an end supporting a spacer (29), the carriage (31) connecting several tie rods (32),
at least one of a ramp integral with the framework (11), projecting towards the frame (12) or a ramp integral with the frame (12), projecting towards the framework (11), the spacer (29) being disposed in contact with said ramp and transmitting a lifting force from the framework (11) to the frame (12) during the first stroke part.

3. The device according to claim 2, wherein the spacer (29) comprises a rolling bearing (34) rolling on the ramp integral with the framework (11) and a rolling bearing (34) rolling on the ramp integral with the frame (12), the bearings (34) having external surfaces of revolution, the spacer (29) being disposed between said ramps (44, 45) and transmitting a lifting force from the ramp integral with the framework (11) to the ramp integral with the frame (12) during the first stroke part.

4. The device according to claim 2, wherein the ramps (44, 45) have a constant slope.

5. The device according to claim 1, wherein the arms of the scissors (18) are rectangular cross-section bars, each arm being hinged to another of said arms through a central hinge axis (25).

6. The device according to claim 1, wherein the stationary framework (11) is provided with height-adjustable feet, relative to a pit ground on which the framework (11) rests, and the framework (11) comprises studs supporting the frame (12) in the low position, the drive assembly (14) being disengaged from the weight of the frame in the low position.

7. The device according to claim 2, wherein at least one shear arm comprises an oblong port sliding with the actuator (15), said oblong port being traversed in the first stroke part, the actuator (15) abutting against one end of said oblong port in the second stroke part.

8. The device according to claim 1, wherein the device has symmetry with respect to a vertical plane and said actuator (15) is disposed between the scissors (18) in the low position.

9. The device according to claim 2, wherein said carriage (31) has a substantially horizontal displacement over the second stroke part and the elevation of the frame (12) as a function of the actuator (15) is independent of the scissors (18) over the first stroke part and dependent on the scissors (18) over the second stroke part.

10. The device according to claim 1, further comprising a guard post integral with the movable plate (13) and provided with flaps, disposed on three sides of the movable plate (13), the flaps being retracted in the low position and raised in the high position and at least during the second stroke part, and the actuator (15) has constant speed from the first to the second stroke part.
